(19) United States
(12) Patent Application Publication
(10) Pub. No.: US 2009/0169440 A1
(43) Pub. Date: Jul. 2, 2009

(54) POLLUTION TREATMENT DEVICE FOR VOLATILE ORGANIC GAS

(75) Inventor: Quanhua NIU, Beijing (CN)

Correspondence Address: YING CHEN;Chen Yoshimura LLP, 255 S. GRAND AVE., # 215, LOS ANGELES, CA, 90012, US

(73) Assignee: Haisibote ( Beijing ) Science and Technology Co., Ltd., Beijing (CN)

(21) Appl. No.: 12/110,464

(22) Filed: Apr. 28, 2008

(30) Foreign Application Priority Data
Dec. 28, 2007 (CN) 200710304595.X

(51) Int. Cl. B01D 53/34

(52) U.S. Cl. 422/177

(57) ABSTRACT

This invention relates A pollution treatment device for volatile organic gas, comprising scrubbing tower, catalytic oxidation tank, liquid storage tank and ozonizer, wherein said scrubbing tower has scrubbing liquid nozzles in the middle of its inside space, sieve plates in the lower and gas-liquid cyclone separators in the upper, its air inlet is located lower than said sieve plates and its outlets higher than said gas-liquid device; said catalytic oxidation tank has photocatalyst particles in it, its air inlet is at its bottom and its air outlet is on its top; said ozonizer has ozone contactor for dissolving ozone in water; the nozzle pipe of said scrubbing tower is linked with said liquid storage tank; the water outlet at the bottom of said scrubbing tower is linked with the water inlet at the bottom of said catalytic oxidation tank. This device has good treatment effect, simple structure and lower operation cost relatively, suitable to treat various gaseous pollutants.

### BACKGROUND OF THE INVENTION

1. Field of the Invention

This invention relates a pollution treatment device for volatile organic gas, mainly applied in purification treatment of exhaust gas generated from semiconductor manufacturing.

2. Description of the Related Art

In semiconductor manufacturing, exhaust gas contains a large amount of volatile organic gas polluting atmospheric environment, such as isopropanol, acetone, methyl ethyl ketone and some high-boiling substances. At present, rotor concentration incineration, activated carbon adsorption and wet scrubbing are usually adopted to treat the exhaust gas. However, such treatment will bear high operation cost for an excessive consumption of fuel is needed in rotor concentration incineration and activated carbon needs to be replaced frequently in activated carbon adsorption. In addition, the method of rotor concentration incineration has less removal effect for high-boiling substances and the adsorption capacity of adsorbent material used in rotor concentrator will be destroyed in the treatment and removing efficiency to pollutant will continuously reduced. The wet scrubbing method, relying on the feature that most of pollutants will dissolved in water, transfers pollutants from gas phase to liquid phase and then removes them by oxidation. But a large amount of clean water will needed and plenty of sewage water will discharged to keep high treatment efficiency. In the treatment, oxidation and scrubbing is carried out simultaneously and oxidants should be dissolved in scrubbing water. If an oxidant is excessive, it will be left in scrubbing water. If the contact time is short, the efficiency will be decreased. Many oxidants can be used in this method and among them, ozone bears a higher efficiency. But at present, oxidation by ozone is mainly used as a pretreatment method in a subsequent treatment procedure in water and sewage water treatment, aimed at disinfecting or removing some organic materials. The simple reaction tank is enough in above procedure, but such a tank is not suitable in the removing of organic materials.

### SUMMARY OF THE INVENTION

To overcome the above disadvantages of the existing technology, the present invention provides a pollution treatment device for volatile organic gas, which possesses well treatment effect, simple structure and lower operation cost relatively.

The technical solution to realize above purposes is: a pollution treatment device for volatile organic gas, comprising scrubbing tower, catalytic oxidation tank, liquid storage tank and ozonizer, wherein said scrubbing tower has scrubbing liquid nozzles in the middle of its inside space, sieve plates in the lower and gas-liquid cyclone separators in the upper, its air inlet is located lower than said sieve plates and its outlets higher than said gas-liquid device; said catalytic oxidation tank has photocatalyst particles in it, its air inlet is at its bottom and its air outlet is on its top; said ozonizer has ozone contactor for dissolving ozone in water; the nozzle pipe of said scrubbing tower is linked with said liquid storage tank; the water outlet at the bottom of said scrubbing tower is linked with the water inlet at the bottom of said catalytic oxidation tank.

Because the scrubbing tower has a high-efficient scrubbing of spray scrubbing and sieve plate scrubbing, it can improve the scrubbing effect, reduce the residues of volatile gas molecules in gas, lower the pollutant concentration in gas after treatment and get a good purification effect; because the scrubbing tower has gas-liquid cyclone separators in it, it can remove scrubbing liquid from discharged gas, which is not only favorable to decrease the consumption of scrubbing liquid, but also favorable to avoid air pollution by the pollutants dissolved in scrubbing liquid; because the catalytic oxidation tank has photocatalyst particles in it, it can get a higher oxidation speed and use ozone more effective to reduce investment and operation cost; because the water discharged from catalytic oxidation tank return to the liquid storage tank, the water can reused to reduce water and ozone consumption.

### BRIEF DESCRIPTION OF THE DRAWINGS

FIG. 1 is a structural scheme of this device;

### DETAILED DESCRIPTION OF THE PREFERRED EMBODIMENTS

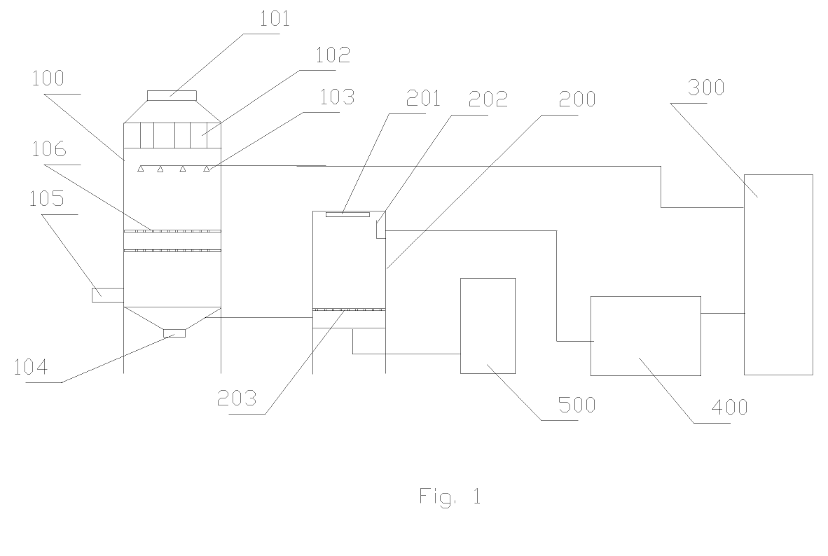

With reference to FIG. 1 and FIG. 2, a pollution treatment device for volatile organic gas comprising scrubbing tower 100, catalytic oxidation tank 200, liquid storage tank 300, and ozonizer 500, wherein said scrubbing tower has scrubbing liquid nozzles 103 in the middle of its inside space, sieve plates 106 in the lower and gas-liquid cyclone separators 102 in the upper, its air inlet 105 is located lower than said sieve plates and its outlets 101 higher than said gas-liquid device; said catalytic oxidation tank has photocatalyst particles in it, its air inlet is at its bottom and its air outlet is on its top; said ozonizer has ozone contactor for dissolving ozone in water; the nozzle pipe of said scrubbing tower is linked with said liquid storage tank; the water outlet at the bottom of said scrubbing tower is linked with the water inlet at the bottom of said catalytic oxidation tank.

The quantity of said sieve plates could be one or two layers and said nozzles evenly distribute on the cross section of tower space; water sprayed drops on the sieve plate will form a water layer, gas propping up water by passing sieve plate from the lower forms some bubbles, which dissolve the volatile gas in water through mixing and impacting with water. This scrubbing efficiency is better than spray scrubbing.

Said gas-liquid cyclone separator composed of some folded plates separate the liquid in it depending on inertia and gravity through the change of gas flow direction.

Said water outlet of the scrubbing tower is located at one side of lower part of sieve plate in order to avoid sludge depositing at the bottom of tower to flow into catalytic oxidation device.

Said central bottom of the scrubbing tower is equipped with sewage outlet 104, which is used to discharge sludge depositing at the bottom of tower.

Said catalytic oxidation tank is equipped with ultraviolet lamp 201 in interior irradiating to it; said ultraviolet lamp is covered by silica tubes, which possessed protective effect, and could keep the activity of photocatalyst particles by ultraviolet lamp irradiating.

Said catalytic oxidation tank is equipped with sieve meshes blocking water inlet and outlet, or with overflow weir 202 in the upper, which are used to prevent photocatalyst particles flowing out.

The upper part of water inlet of said catalytic oxidation tank is equipped with water even plate 203, which is used to evenly distribute water; the pore diameter on plate is smaller than the diameter of photocatalyst particles, in order to block photocatalyst particles to the upper of plate and avoid water to deposit in dead space; while operating, the water in upper stream at the bottom will thrust photocatalyst particles up and forms the fluidized state.

The water inlet of said catalytic oxidation tank could be set up at the bottom of tower, and water outlet could be set up on the top of tower; from this, the water in upper stream thrusts photocatalyst particles up, which could improve the chance for photocatalyst contacting pollutants in water and reduce resistance.

The settling chamber 400 is equipped between said catalytic oxidation tank and said liquid storage tank; the scrubbing liquid flowing from catalytic oxidation tank will firstly enter into settling chamber to deposit the solid particles in liquid; the water outlet end of said settling chamber could be set up with filter layer, in order to filtrate water, reduce solid particles in scrubbing liquid, and avoid damage to nozzles.

What is claimed is:

1. A pollution treatment device for volatile organic gas, comprising a scrubbing tower, a catalytic oxidation tank, a liquid storage tank and an ozonizer,
wherein said scrubbing tower includes scrubbing liquid nozzles in a middle part of its inside space, sieve plates in a lower part of the inside space, gas-liquid cyclone separators in an upper part of the inside space, an air inlet located lower than said sieve plates, and outlets located higher than said gas-liquid cyclone separators,
wherein said catalytic oxidation tank includes photocatalyst particles, an air inlet located at its bottom, and an air outlet located at its top,
wherein said ozonizer includes an ozone contactor for dissolving ozone in water;
wherein a nozzle pipe of said scrubbing tower is linked with said liquid storage tank;
wherein a water outlet at a bottom of said scrubbing tower is linked with a water inlet at a bottom of said catalytic oxidation tank.

2. The system of claim 1, wherein said sieve plates have two layers and said nozzles are evenly distributed in a cross section of an inside space of the scrubbing tower.

3. The system of claim 2, wherein said gas-liquid cyclone separator includes folded plates.

4. The system of claim 1, wherein the water outlet of said scrubbing tower is located at one side of a lower part of the sieve plate.

5. The system of claim 4, wherein the scrubbing tower further includes a sewage outlet located in a center of the bottom of the scrubbing tower.

6. The system of claim 1, wherein said catalytic oxidation tank further includes an ultraviolet lamp.

7. The system of claim 6, wherein said ultraviolet lamp is covered by silica tubes.

8. The system of claim 7, wherein said catalytic oxidation tank further includes a water inlet, a water outlet, and sieve meshes covering the water inlet and the water outlet.

9. The system of claim 8, wherein the water inlet of said catalytic oxidation tank is located in its bottom and the water outlet is located in its top.

10. The system of claim 9, further comprising a settling chamber having a water outlet and a filter layer at the water outlet side, wherein the settling chamber is located between said catalytic oxidation tank and said liquid storage tank.

11. The system of claim 3, wherein said catalytic oxidation tank further includes an ultraviolet lamp.

12. The system of claim 11, wherein said ultraviolet lamp is covered by silica tubes.

13. The system of claim 12, wherein said catalytic oxidation tank further includes a water inlet, a water outlet, and sieve meshes covering the water inlet and the water outlet.

14. The system of claim 13, wherein the water inlet of said catalytic oxidation tank is located in its bottom and the water outlet is located in its top.

15. The system of claim 14, further comprising a settling chamber having a water outlet and a filter layer at the water outlet side, wherein the settling chamber is located between said catalytic oxidation tank and said liquid storage tank.

16. The system of claim 5, wherein said catalytic oxidation tank further includes an ultraviolet lamp.

17. The system of claim 16, wherein said ultraviolet lamp is covered by silica tubes.

18. The system of claim 17, wherein said catalytic oxidation tank further includes a water inlet, a water outlet, and sieve meshes covering the water inlet and the water outlet.

19. The system of claim 18, wherein the water inlet of said catalytic oxidation tank is located in its bottom and the water outlet is located in its top.

20. The system of claim 19, further comprising a settling chamber having a water outlet and a filter layer at the water outlet side, wherein the settling chamber is located between said catalytic oxidation tank and said liquid storage tank.
